(19) United States
(12) Patent Application Publication
(10) Pub. No.: US 2012/0042848 A1
(43) Pub. Date: Feb. 23, 2012

(54) FUEL STABALIZER METERING DEVICE AND METHOD

(75) Inventors: Adam J. Hellman, Bayside, WI (US); Randall J. Ammentorp, Menomonee Falls, WI (US)

(73) Assignee: Briggs & Stratton Corporation, Wauwatosa, WI (US)

(21) Appl. No.: 12/860,013

(22) Filed: Aug. 20, 2010

(51) Int. Cl. F02B 39/00

(52) U.S. Cl. 123/198 R

(57) ABSTRACT

An apparatus and method discharge fuel stabilizer to a carburetor bowl of an engine during or after completion of engine shutdown.

### BACKGROUND

During prolonged periods of time in which an engine is not used, fuel remaining within the engine may become stale. Such stale fuel may cause corrosion of internal carburetor parts such as jets, seats, needles, o-rings and the like.

### BRIEF DESCRIPTION OF THE DRAWINGS

FIG. 1 is a schematic illustration of an internal combustion engine system according to an example embodiment.

FIG. 2 is a schematic illustration of another embodiment of the internal combustion engine system of FIG. 1.

FIG. 3 is a schematic illustration of another embodiment of the internal combustion engine system of FIG. 1.

FIG. 4 is a schematic illustration of another embodiment of the internal combustion engine system of FIG. 1.

FIG. 5 is a first fragmentary side elevational view of another embodiment of the internal combustion engine system of FIG. 1.

FIG. 6 is a second fragmentary side elevational view of the internal combustion engine system of FIG. 5.

FIG. 7 is a sectional view of the internal combustion engine system of FIG. 5 illustrating a metering device in a loading state.

FIG. 8 is an enlarged sectional view of the internal combustion engine of FIG. 7.

FIG. 9 is a sectional view of the internal combustion engine system of FIG. 5 illustrating the metering device in an unloading state.

FIG. 10 is an enlarged sectional view of the internal combustion engine of FIG. 9.

### DETAILED DESCRIPTION OF THE EXAMPLE EMBODIMENTS

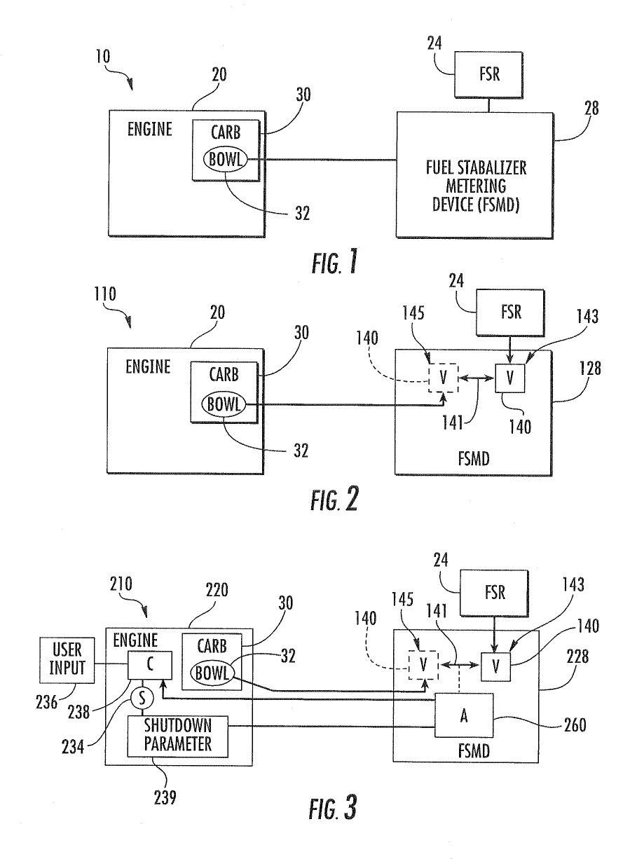

FIG. 1 schematically illustrates an internal combustion engine system 10 according to an example embodiment. System 10 uses fuel stabilizer to reduce corrosion or other damage to a carburetor resulting from stale fuel within the engine. As will be described hereafter, system 10 meters fuel stabilizer to the carburetor of the engine during or after shutdown of the engine. Because the fuel stabilizer is metered during or after shutdown of the engine, fuel within the carburetor is reliably treated without inconveniencing the user and wasteful consumption of fuel stabilizer is reduced.

As shown by FIG. 1, internal combustion engine system 10 includes engine 20, fuel stabilizer reservoir (FSR) 24 and fuel stabilizer metering device (FSMD) 28. Engine 20 (schematically represented) comprises an internal combustion engine having a carburetor 30 with a carburetor bowl 32 (both of which are schematically represented). Engine 20 supplies power or torque to a powered appliance, examples of which include, but are not limited to, riding and walk behind lawnmowers, snow blowers, tillers, pumps, generators and power washers, or other engine powered equipment. Carburetor 30 is a component of engine 20 and provides the required air-fuel mixture to a combustion chamber of the engine based upon engine operating speed and load. Bowl 32 contains or stores fuel prior to the fuel being mixed with air by the carburetor 30.

Fuel stabilizer reservoir 24 comprises a tank, container, chamber or other volume configured to contain and store a fuel stabilizer. Fuel stabilizer reservoir 24 is connected to fuel stabilizer metering device 28 so as to deliver fuel stabilizer to fuel stabilizer metering device 28. Reservoir 24 may have various sizes, shapes and configurations. Reservoir 24 may comprise a reservoir that is refillable while connected to metering device 28 or may be a type that requires disconnection from metering device 28 for refilling or replacement.

Fuel stabilizer metering device 28 comprises a device configured to meter or supply a predetermined amount or volume of fuel stabilizer to bowl 32 of carburetor 30 after initiation of engine shutdown. In one embodiment, metering device 28 does not deliver any stabilizer to engine 20 or bowl 32 of carburetor 30 while engine 20 is running (prior to any initiation of shutdown of engine 20). In another embodiment, fuel stabilizer metering device 28 meters fuel stabilizer to bowl 32 of carburetor 30 only after engine shutdown has been completed. In some embodiments, metering device 28 may meter a predefined quantity of fuel stabilizer to bowl 32 of carburetor 30 while the engine is being shut down (but not prior to initiation of engine shutdown) and after shutdown has been completed.

Because of fuel stabilizer metering device 28 meters a predefined quantity or volume of fuel stabilizer, a user of the appliance having engine 20 is not inconvenienced by having to measure the appropriate amount of fuel stabilizer and by having to manually supply fuel stabilizer to anything other than reservoir 24. Because fuel stabilizer metering device 28 meters a predefined quantity or volume of fuel stabilizer only at least after initiation of engine shut down or after completion of engine shutdown, most, if not all, of the fuel stabilizer added to bowl 32 of carburetor 30 remains within bowl 32 to stabilize fuel and is not consumed immediately prior to shutdown of engine 20. As a result, wasteful consumption of fuel stabilizer is reduced.

According to one embodiment, fuel stabilizer metering device 28 delivers a metered amount of fuel stabilizer to bowl 32 in response to user input (either by a manual actuation of a mechanical input such as a lever, squeezing or compression of a compressible fluid fillable bulb filled with the fuel stabilizer or by actuation of an electrical switch or other electrical device causing release or metering of fuel stabilizer). In such embodiments, metering device 28 is configured to inhibit such manual input until at least after initiation of engine shutdown or is configured to delay the delivery of fuel stabilizer to bowl 32 from a time that the manual input is provided to at least after initiation of engine shutdown.

In yet other embodiments, fuel stabilizer metering device 28 may alternatively be configured to automatically deliver a metered amount of fuel stabilizer to bowl 32 of carburetor 30 until at least after initiation of engine shutdown. For purposes of this disclosure, such “automatic” delivery of fuel stabilizer means that the fuel stabilizer is delivered to carburetor 30 without a person (user) having to take any action to initiate the delivery of fuel stabilizer to carburetor 30, other than making sure that the fuel stabilizer reservoir 24 contains the fuel stabilizer and other than initiating engine shutdown. In one embodiment, parameters associated with the shutting down or completion of shutdown of engine 20 may be sensed by one or more sensors, wherein a controller generates control signals causing an actuator to deliver the metered fuel stabilizer to bowl 32 of carburetor 30. In yet another embodiment, the parameters associated with shutting down or completion of shutdown of engine 20 may themselves actuate or directly cause an actuator to deliver the metered amount of fuel stabilizer to bowl 32 of carburetor 30. Examples of such engine shutdown parameters may include, but are not limited to, vacuum or pressure, temperature, fuel flow, electrical current flow and the like.

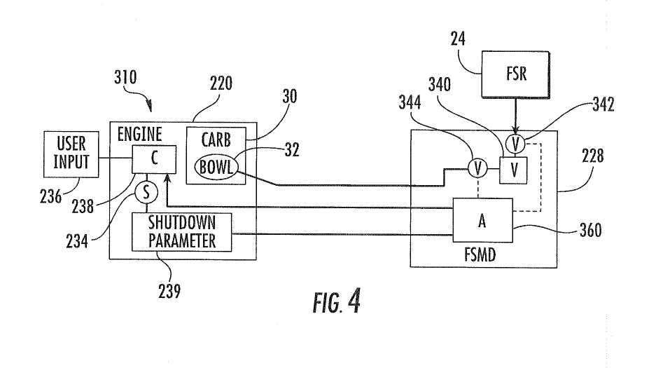

FIG. 2 schematically illustrates internal combustion engine system 110, a particular embodiment of system 10. Those elements or components of system 110 which are the same as elements or components of system 10 are numbered similarly. System 110 includes fuel stabilizer metering device 128, a particular embodiment of fuel stabilizer metering device 28.

As shown by FIG. 2, fuel stabilizer metering device 128 includes a volume 140 (schematically illustrated). Volume 140 comprises a cavity, container, channel, groove, bore, reservoir, chamber or other volume configured to receive and contain a predefined stationary (non-flowing) volume or amount fuel stabilizer from reservoir 24. As indicated by arrows 141, fuel stabilizer metering device 128 moves volume 140 between a loading position 143 and an unloading position 145. In the loading position 143, volume 140 is located so as to be connected or connectable to fuel stabilizer reservoir 24. In the unloading position 145 (shown in broken lines), volume 140 is located so as to be connected or connectable to bowl 32 of carburetor 30 to allow the release, delivery or discharge of the fuel stabilizer within volume 140 to bowl 32 of engine 20. In one embodiment, volume 140 moves to the unloading position 145 during (after initiation of) engine shutdown. In other words, volume 140 does not begin moving towards the unloading position until at least after initiation of engine shutdown. In another embodiment, volume 140 moves to the unloading position 145 only after completion of engine shutdown. In such embodiments, volume 140 may be filled (either fully or least partially) during operation of engine 20 or after engine shutdown has been initiated.

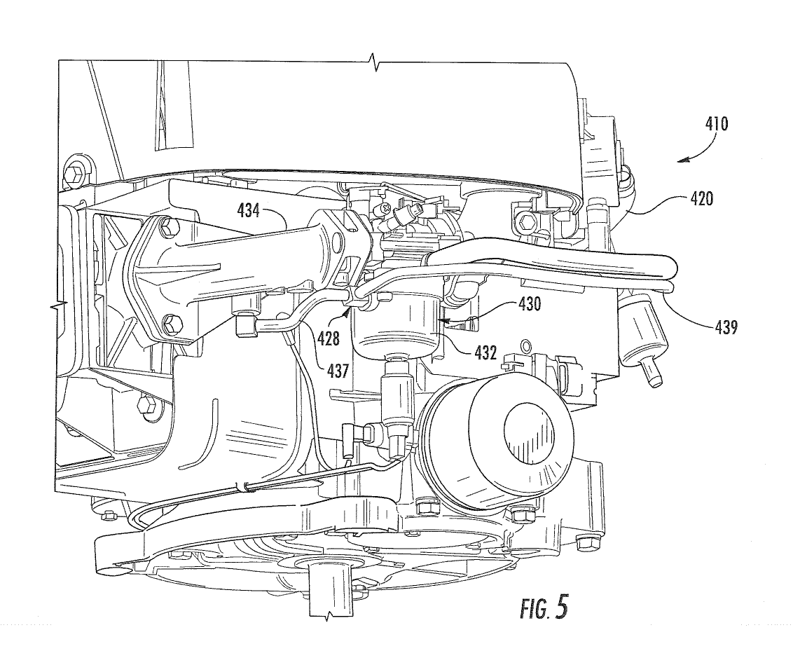

FIG. 3 schematically illustrates internal combustion engine system 210, a particular embodiment of system 110. Internal combustion engine system 210 includes engine 220, fuel stabilizer reservoir 24 and fuel stabilizer metering device 228. Engine 220 is similar to engine 20 in that engine 220 includes a carburetor 30 having a bowl 32. Engine 220 additionally includes or is associated with a sensor 234, a user input 236 and a controller 238.

Sensor 234 comprises one or more sensors configured to sense or detect an engine shutdown parameter 239 and to transmit signals, such electrical signals, to controller 238 indicating the status of the sensed shutdown parameter. Shutdown parameter 239 comprises a parameter or characteristic of engine 220 that changes in response to initiation of engine shutdown or completion of engine shutdown. Examples of an engine shutdown parameter 239 include, but are not limited to, vacuum or pressure, temperature, fuel flow, electrical current flow and the like. For example, in one embodiment, sensor 234 senses a drop in negative pressure or vacuum in the intake manifold of engine 220. In response to detecting a drop in the vacuum in the intake manifold of engine 220, indicating that engine 220 is in the process of being shut down or has completed shut down, sensor 234 transmits a signal to controller 238. In other embodiments, other shutdown parameters 239 may be detected or sensed by sensor 234.

User input 236 comprises a mechanism or device associated with or provided as part of engine 220 which is configured to receive input from a person. In one embodiment, user input 236 is configured to receive such input from a person initiating or causing shutdown of engine 220. In yet another embodiment, input 236 is configured to receive such input for a person indicating that engine 220 has been shut down or is in process of being shut down or requesting metering of fuel stabilizer to carburetor 30 by metering device 228. User input 236 is operatively or communicatively connected or coupled to controller 238.

For purposes of this disclosure, the term “coupled” shall mean the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature. The term “operably coupled” or “operatively coupled” shall mean that two members are directly or indirectly joined such that motion may be transmitted from one member to the other member directly or via intermediate members. The term “fluidly coupled” shall mean that two or more fluid transmitting volumes are connected directly to one another or are connected to one another by intermediate volumes or spaces such that fluid may flow from one volume into the other volume. The term “communicatively coupled” shall mean that two devices are directly or indirectly connected on another such that electrical signals may be transmitted therebetween.

In one embodiment, user input 236 may comprise a lever, key ignition, a pushbutton, switch, touchpad, touch screen, keypad or an automatic shutdown mechanism. Examples of an automatic shutdown mechanism include a kill bar or other safety mechanism that automatically shuts down the engine such as when a sufficient amount of weight is no longer on the seat of the mower. In other embodiments, other mechanical or electrical mechanisms may be utilized for user input 236.

Controller 238 comprises one or more processing units configured to receive input or signals from sensor 234 and user input 236 and to further generate control signals for directing the operation of fuel stabilizer metering device 228 based upon such input from sensor 234 and user input 236. For purposes of this application, the term “processing unit” shall mean a presently developed or future developed processing unit that executes sequences of instructions contained in a memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. For example, controller 238 may be embodied as part of one or more application-specific integrated circuits (ASICs). Unless otherwise specifically noted, the controller is not limited to any specific combination of hardware circuitry and software, nor to any particular source for the instructions executed by the processing unit.

Fuel stabilizer metering device 228 is a particular embodiment of fuel stabilizer metering device 128. As shown by FIG. 3, fuel stabilizer metering device 228 is specifically illustrated as including an actuator 260. Actuator 260 comprises one or more mechanisms continue to move volume 140 between the loading position 143 and the unloading position 145. In one embodiment, actuator 260 may comprise a pneumatically, hydraulically or electrically powered device. Examples of such devices include hydraulic or pneumatic piston-cylinder assemblies or electric solenoids.

In another embodiment, actuator 260 may comprise one or more mechanisms that utilize forces naturally produced by engine 220 to move volume 140. For example, negative and/or positive air or gas pressures within engine 220 may be utilized to move volume 140. Alternatively, force or motion produced by engine 220 may be transmitted via one or more cams, linkages, transmissions, power trains or the like so to move volume 140. In each of such embodiments, volume 140 may be biased to one of the loading or unloading positions by a spring or similar mechanism, wherein the hydraulic, pneumatic, electrical or engine produced force moves volume 140 against the bias to the other of the loading or unloading position. Actuator 260 moves volume 140 to the unloading position 145 at least after initiation of engine shut down or after completion of engine shutdown.

In the example illustrated, internal combustion engine system 210 is configured to operate in a selected one of multiple available modes or settings which may be set by the person using system 210. In a first selectable mode, controller 238 generates control signals causing actuator 260 to move volume 140 to the unloading position 145 in response to signals from user input 236 initiating or causing shutdown of engine 220. For example, in one embodiment a person may turn the ignition key to shut engine 220 off. Such action results in signals being transmitted to controller 238, where the controller 238 generates signals causing actuator 260 to move volume 140 to the unloading position 145 so as to discharge fuel stabilizer to bowl 32 of carburetor 30. In some embodiments, a delay timer or other delay mechanism may be provided such that the actual movement of volume 140 to the unloading position 145 occurs at a predetermined time period following receipt of user input 236 shutting down engine 220 by controller 238. During operation of engine 220, or during start up of engine 220, controller 238 generates control signals causing actuator 260 to move volume 140 to the filling or loading position 143, wherein volume 140 is filled with a predetermined volume of fuel stabilizer from reservoir 24.

In a second selectable mode, controller 238 generates control signals causing actuator 260 to move volume 140 to the unloading position 145 in response to signals received from user input 236 requesting that fuel stabilizer be provided to bowl 32 of carburetor 30 by metering device 228. In such an embodiment, if such user input is received prior to initiation of engine shut down, input of the request at user input 236 is inhibited or prevented or actual actuation of volume 140 to the unloading position by actuator 260 is paused or delayed until initiation of engine shutdown has occurred or until engine shutdown has been completed. In one embodiment, controller 238 may simply delay the transmission of control signals to actuator 260. In another embodiment, actuator 260, itself, may delay actuation or movement of volume 140.

In a third selectable mode, controller 238 generates control signals causing actuator 260 to move volume 140 to the unloading position 145 in response to receiving signals from sensor 234 based upon one of more sensed shut down parameters 239 indicating that engine shutdown has been initiated or has been completed. For example, in one embodiment, sensor 234 senses a drop in vacuum pressure in the intake manifold of engine 220. When the drop in vacuum is to such an extent that it indicates that engine 220 is being shutdown, controller 238 generates control signals causing actuator 260 to move volume 140 to the unloading position 145.

In a fourth selectable mode, actuator 260 is directly connected to engine 220 so as to utilize forces or changes in engine parameters such that the forces naturally occurring during engine shut down are what actually move volume 140. For example, negative and/or positive air or gas pressures within engine 220 may be utilized to move volume 140. Alternatively, force or motion produced by engine 220 may be transmitted via one or more cams, linkages, transmissions, power trains or the like so to move volume 140. In each of such embodiments, volume 140 may be biased to one of the loading or unloading positions by a spring or similar mechanism, wherein the hydraulic, pneumatic, electrical or engine produced force moves volume 140 against the bias to the other of the loading or unloading position. Actuator 260 moves volume 140 to the unloading position 145 at least after initiation of engine shut down or after completion of engine shutdown.

Although internal combustion engine system 210 is illustrated and described as having each of the above for selectable modes or settings, in other embodiments, internal combustion engine system 210 may include a fewer number of such available modes. Although fuel stabilizer metering device 228 is schematically illustrated as being separate from engine 220, in other embodiments, fuel stabilizer metering device 228 may be embodied as part of engine 220 or may be provided as a module or add-on including the illustrated components, including some of the components of engine 220 or including less than all the components illustrated. For example, in one embodiment, metering device 228 may be incorporated as part of a carburetor unit which is configured to be mounted to a remainder of an engine.

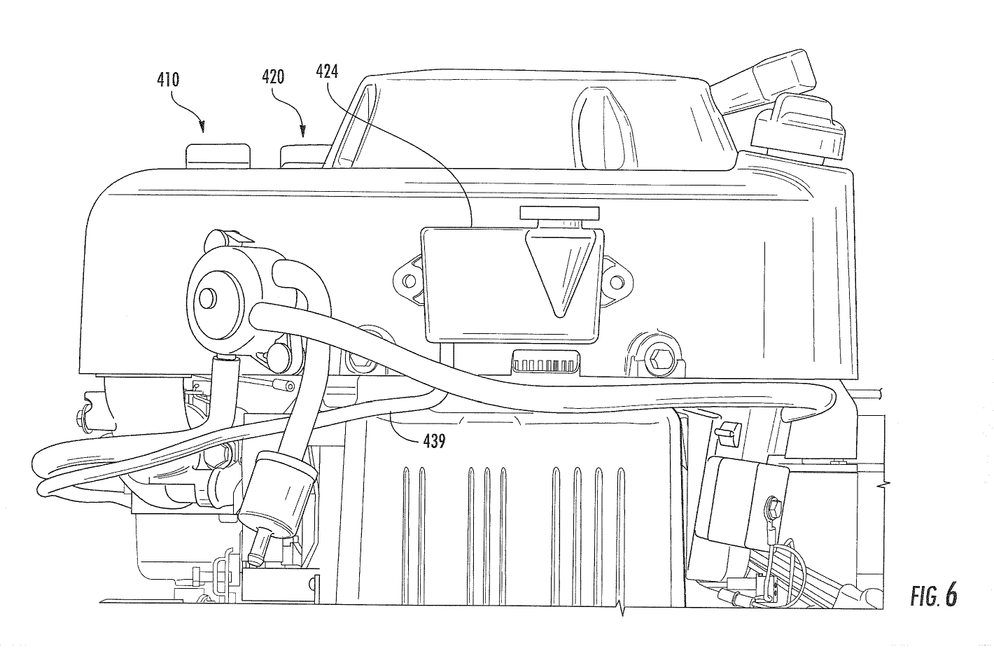

FIG. 4 schematically illustrates internal combustion engine system 310, another embodiment of internal combustion engine system 210. Internal combustion engine system 310 is similar to internal combustion engine system 210 except that internal combustion engine system 310 includes volume 340 and valves 342, 344 in place of volume 140 and further includes actuator 360 in place of actuator 260. Unlike volume 140, volume 340 is substantially stationary. Valve 342 comprises a mechanism configured selectively connect volume 340 to fuel stabilizer reservoir 24. Valve 342 is actuatable between an open position or state, allowing fuel stabilizer to flow from reservoir 24 into volume 340 and a closed state blocking the flow of fuel stabilizer from fuel stabilizer 24 into volume 340. Valve 344 comprises a mechanism configured selectively connect volume 340 to bowl 32 of carburetor 30. Valve 344 is actuatable between an open position or state, allowing fuel stabilizer to flow from volume 340 to or at least towards bowl 32 of carburetor 30 and a closed position or state blocking or occluding flow of fuel stabilizer from volume 340.

Actuator 360 comprises one or more actuators or mechanisms configured to selectively actuate valves 342, 344 between their open and closed states. In one embodiment, actuator 360 may comprise a pneumatically, hydraulically or electrically powered device. Examples of such devices include hydraulic or pneumatic piston-cylinder assemblies or electric solenoids.

In another embodiment, actuator 360 may include mechanisms that utilize forces naturally produced by engine 220 to move valves 342, 344. For example, negative and/or positive air or gas pressures within engine 220 are what actually move valves 342, 344. Alternatively, force or motion produced by engine 220 may be transmitted via one or more cams, linkages, transmissions, power trains or the like so to move valves 342, 344. In each of such embodiments, valves 342, 344 may be biased to one of the open or closed positions by a spring or similar mechanism, wherein the hydraulic, pneumatic, electrical or engine produced force moves valves 342, 344 against the bias to the other of the open or closed position. Actuator 360 moves or actuates valve 344 to the open state at least after initiation of engine shut down or after completion of engine shutdown. Prior to valve 344 being actuated to the open state, actuator 360 also actuates valve 342 to its closed state. Closing of valve 342 may occur immediately preceding the opening of valve 344 or may occur well before the opening of valve 344 during the operation of engine 220. Likewise, actuator 360 closes 344 prior to opening valve 342. Valve 342 may be actuated to its open state to at least partially fill volume 340 at any time while valve 344 is closed.

Internal combustion engine system 310 offers each of the selectable modes described above with respect to system 210. Unlike the modes described above with respect to system 210, the modes of operation for system 310 actuate valve 342, 344 instead of moving a metering volume. As with system 210, system 310 may include a fewer of such selectable modes. In one embodiment, system 310 may include a single mode of operation.

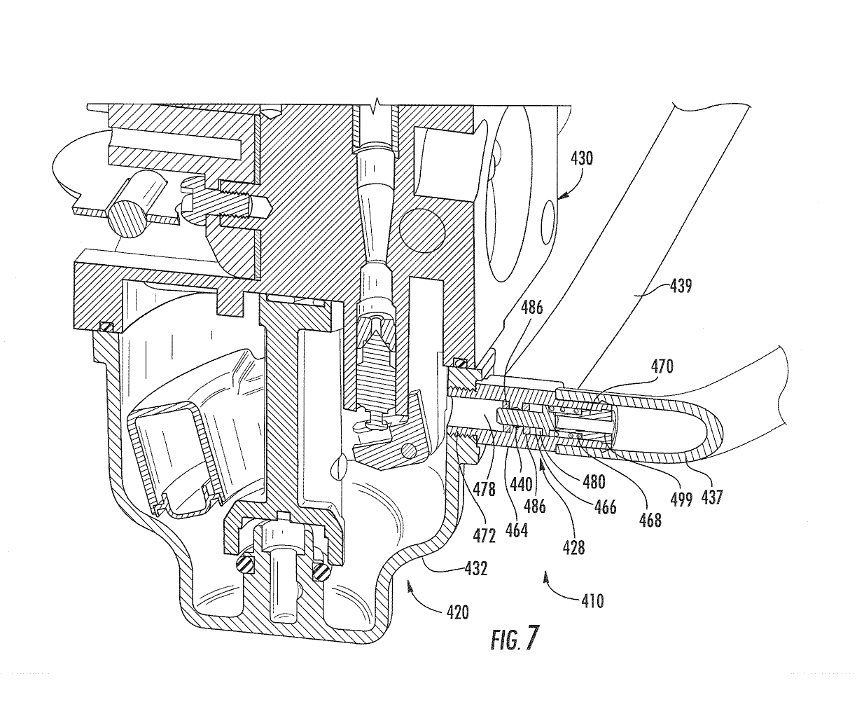

FIGS. 5-10 illustrate internal combustion engine system 410, a particular embodiment of internal combustion engine system 20. As shown by FIGS. 5 and 6, internal combustion engine system 410 includes engine 420, fuel stabilizer reservoir 424 (shown in FIG. 6) and fuel stabilizer metering device 428 (shown in FIG. 5). Engine 420 comprises an internal combustion engine having a carburetor 430 with a carburetor bowl 432, and an intake manifold 434. Engine 420 supplies power or torque to a powered appliance, examples of which include, but are not limited to, riding and walk behind lawnmowers, snow blowers, tillers, pumps and power washers, or other engine powered equipment. Intake manifold comprise a component of engine 420 that distributes an air-fuel mixture from carburetor 30 to one or more cylinders of engine 420. Carburetor 430 is a component of engine 420 and provides the required air-fuel mixture to a combustion chamber of the engine based upon engine operating speed and load. Bowl 432 contains or stores fuel prior to the fuel being mixed with air by the carburetor 430.

Intake manifold 434 comprises engine component that distributes the air-fuel mixture from carburetor 430 to cylinders of engine 420. As shown by FIGS. 5 and 6, intake manifold 434 is pneumatically connected or fluidly coupled to fuel stabilizer metering device 428 by conduit 437, such as a tubing or hose. In other embodiments, metering device 428 may be fluidly coupled to the intake manifold 434 at other locations or in other manners. After initiation of engine shut down, vacuum pressure within intake manifold 434 decreases until reaching atmospheric pressure. As will be described hereafter, fuel stabilizer metering device 428 utilizes this drop in vacuum pressure within manifold 434 during an engine shutdown, as communicated and transmitted to metering device 428 by conduit 437, to automatically meter fuel stabilizer to bowl 432 of carburetor 430.

Fuel stabilizer reservoir 424 (shown in FIG. 6) comprises a tank, container, chamber or other volume configured to contain and store a fuel stabilizer. Fuel stabilizer reservoir 424 is connected to fuel stabilizer metering device 428 so as to deliver fuel stabilizer to fuel stabilizer metering device 428. Reservoir 424 may have various sizes, shapes and configurations. In the example illustrated, reservoir 424 comprises a reservoir that is refillable while connected to engine 420 and metering device 428. In other embodiments, reservoir 424 may be a type that requires disconnection from metering device 428 and/or engine 420 for refilling or replacement. As shown by FIGS. 5 and 6, fuel stabilizer reservoir 424 is connected or fluidly coupled to fuel stabilizer metering device 428 by a conduit 439, such as a tubing or hose. In other embodiments, fuel stabilizer reservoir 424 is fluidly coupled to metering device 428 in other fashions.

Fuel stabilizer metering device 428 comprises a device configured to meter or supply a predetermined amount or volume of fuel stabilizer to bowl 432 of carburetor 430 after initiation of engine shutdown. In one embodiment, metering device 428 does not deliver any stabilizer to engine 420 or bowl 432 of carburetor 430 while engine 420 is running (prior to any initiation of shutdown of engine 420). In another embodiment, fuel stabilizer metering device 428 meters fuel stabilizer to bowl 432 of carburetor 430 only after engine shutdown has been completed. In some embodiments, metering device 428 may meter a predefined quantity of fuel stabilizer to bowl 432 of carburetor 430 while the engine is being shut down (but not prior to initiation of engine shutdown) and after shutdown has been completed.

FIGS. 7-10 illustrate fuel stabilizer metering device 428 in more detail. As shown by FIG. 7, metering device 428 comprises body 464, piston or plunger 466, bias 468 and retainer 470. Body 464 comprises a structure having a bowl connecting portion 472, a reservoir connecting portion 474, an intake manifold connecting portion 476, a discharge port 478, plunger guiding cavity 480, plunger passage 482 and fill port 484. Bowl connecting portion 472 comprises that portion of device 428 that is configured to connect to bowl 432 of carburetor 430. In the example illustrated, portion 472 comprises an externally threaded stem configured to thread into an internally threaded bore within bowl 430. In other embodiments, the relationship between portion 472 and bowl 432 may be reversed or other mechanisms may be used to connect portion 472 to bowl 432.

Reservoir connecting portion 474 comprises that portion of metering device 428 configured to be connected to conduit 439 and ultimately to fuel stabilizer reservoir 424 (shown in FIG. 6). Similarly, intake manifold connecting portion 476 comprises that portion of metering device 428 configured to be connected to conduit 437 and ultimately to intake manifold 434 as shown in FIG. 5. In the example illustrated, portion 474 and 476 comprise barbed nipples that sealingly fit into conduits 439 and 437, respectively. In other embodiments, portions 474 and 476 may have other configurations for connecting to conduits 439 and 437, respectively.

Discharge port 478 comprises an internal volume within portion 472 extending from plunger passage 482 and opening into an interior of bowl 432. Plunger guiding cavity 480 comprises a bore configured to receive and guide linear, translating movement of plunger 466. In some embodiments, body 464 may omit cavity 480 where other structures are provided for guiding movement of plunger 466. Plunger passage 482 comprises a passage through which plunger 466 extends and moves. In one embodiment, plunger passage 482 seals about outer circumferential portions of plunger 466. In the example illustrated, additional sealing rings 486 are provided on opposite sides of plunger passage 482 to seal about and against plunger 466 while allowing plunger 466 to slide or move through passage 482. Fill port 484 comprises a passage extending from an interior of portion 474 to an interior of plunger passage 482. In the example illustrated, metering device 428 is substantially T-shaped with plunger passage 482 extending along a central axis and fill port 484 extending substantially perpendicular to the central axis. In another embodiment, fill port 484 may have other configurations.

Plunger 466 comprises a member movable through plunger passage 482. Plunger 466 includes shank portion 490, head portion 492 and volume 440. Shank portion 490 extends from head portion 492 and extends through plunger passage 482. Volume 440 comprises an opening or chamber formed within a circumferential portion of shank portion 490. Volume 440 has a predefined volume configured for the purpose of metering a predetermined amount of fuel stabilizer. The actual predetermined volume of volume 440 may vary depending upon characteristics of engine 420 and carburetor 430. In the example illustrated, volume 440 comprises a circumferential groove completely encircling shank portion 490. In other embodiments, volume 440 may comprise a notch or other cavity only partially extending about shank portion 490. In yet another embodiment, volume 440 may comprise a bore partially or completely extending through shank portion 490 in a radial direction.

Head portion 492 extends from shank portion 490 and includes a neck portion 494 and a collar 496. Neck portion 494 extends from collar 496 and projects into bias 468 to seat bias 468 against plunger 466. Collar 496 projects radially outward from that portion 494 into contact with interior sides of cavity 480. Collar 496 outer peripheral surfaces that cooperate with surfaces of cavity 480 to guide movement of plunger 466. Collar 496 further provides a surface or shoulder against which bias 468 may apply force to plunger 466. In addition, collar 496 sufficiently seals against sides of cavity 480 such that changes in vacuum pressure communicated from intake manifold 434 by conduit 437 may move plunger 466. In other embodiments, plunger 466 may have other configurations.

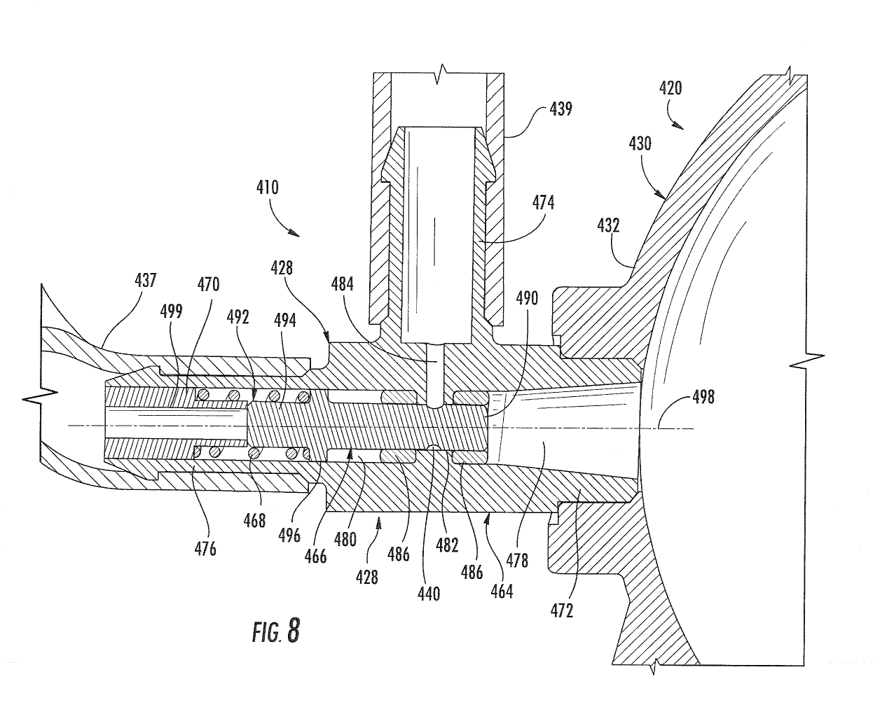

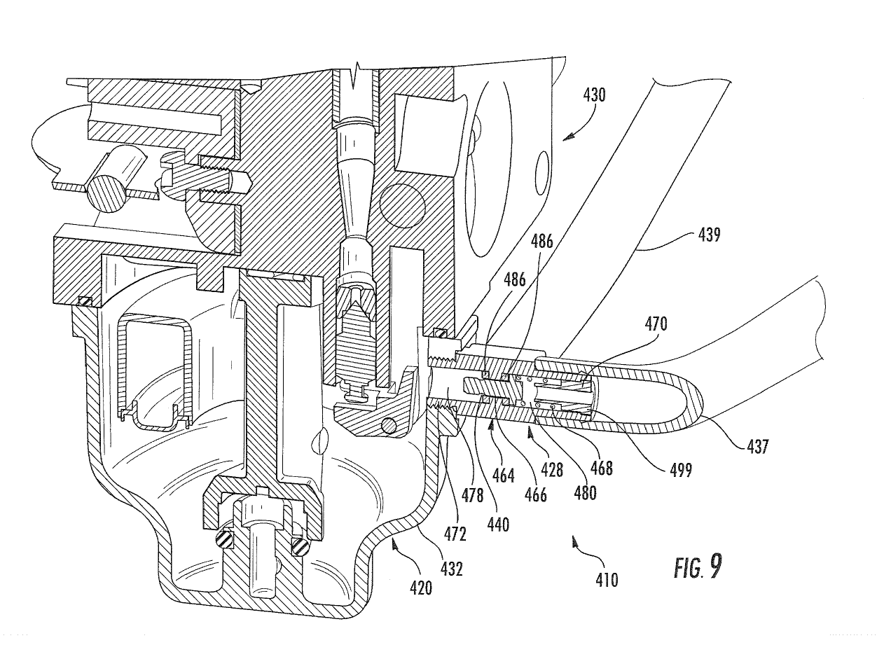

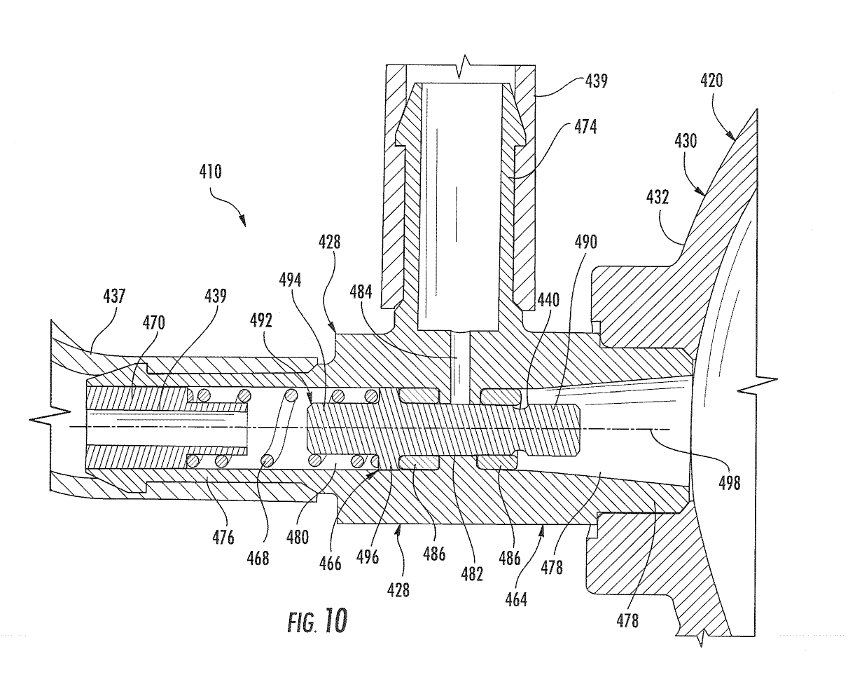

As shown by FIGS. 8 and 10, plunger 466 is movable between a loading position (shown in FIG. 8) in which volume 440 is fluidly coupled to fill port 484, allowing volume 440 to at least be partially filled with fuel stabilizer through port 484, and a discharge or unloading position (shown in FIG. 10) in which volume 440 is fluidly coupled to discharge port 478, allowing fuel stabilizer within volume 440 to be released or discharged into port 478 and into bowl 432. Although plunger 466 is illustrated as linearly moving (without rotation about axis 498) between the loading and unloading positions along central axis 498, in other embodiments, plunger 466 may alternatively rotate about axis 498 between the loading and unloading positions. For example, in another embodiment, plunger passage 482 may be internally threaded, while shank portion 490 is externally threaded, wherein force applied to plunger 466 in a direction parallel to axis 498 causes rotation of plunger 466 about axis 498 and also causes plunger 466 to move along axis 498.

Bias 468 comprises a member configured to resiliently bias plunger 466 towards the unloading position shown in FIG. 10. In the example illustrated, bias 468 comprises a compression spring captured between collar 496 of plunger 466 and retainer 470. The spring of bias 468 has a spring constant such that during operation of engine 420, the vacuum pressure applied to plunger 466 from intake manifold 434) shown in FIG. 5) through conduit 437 is sufficiently strong so to resist bias 468 and retain plunger 460, against the bias of bias 468, in the loading position shown in FIG. 8.

In other embodiments, bias 468 may have other configurations. For example, in other embodiments, bias 468 may comprise a tension spring operatively couple to plunger 466 on an opposite side of plunger passage 482. In yet other embodiments, bias 468 may alternatively be configured to bias plunger 466 towards the loading position, wherein forces resulting from the shutdown of engine 420 are utilized to overcome the force of bias 468 to move plunger 466 to the unloading position when the engine is shut down.

Retainer 470 comprises a member inserted and fixedly retained in cavity 480. Retainer 470 is configured to capture bias 468 between retainer 470 and collar 496 of plunger 466. Retainer 470 includes an internal bore 499 through which vacuum pressure is transmitted through conduit 437 and may be applied to plunger 466 to retain plunger 466 in the loading position while the engine is running. In other embodiments, retainer 470 may have other configurations or may be omitted where other mechanisms or surfaces are used to bear against bias 468.

During running of engine 420, a vacuum pressure exists within intake manifold 434 (shown in FIG. 5) of sufficient strength to hold plunger 466 in the loading position against the force of bias 468. As shown by FIGS. 7 and 8, during this time, fuel stabilizer flows from reservoir 424, through conduit 439, and into volume 440 of plunger 466 through fill port 484. Upon initiation of the shutdown of engine 420, vacuum pressure within intake manifold 434 begins to decline or drop.

As shown by FIGS. 9 and 10, in response to the vacuum pressure within intake manifold 434 dropping below a predetermined threshold value, bias 468 is able to overcome the decreased vacuum pressure, urging plunger 466 to the unloading position. In the unloading position, the fuel stabilizer within volume 440 is released into bowl 432 of carburetor 430. At the same time, fill port 484 is substantially closed off or sealed by shank portion 490. In one embodiment, the spring constant of bias 468 is such that plunger 466 moves to the unloading position during shutdown of engine 420. In another embodiment, the spring constant of bias 468 is such that plunger 466 moves to the unloading position only after complete shutdown of engine 420, wherein the interior of intake manifold 434 is at atmospheric pressure. During startup of engine 420, the vacuum within intake manifold 434 causes plunger 466 to return to the loading position against bias 468.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. An apparatus comprising:
a fuel stabilizer metering device adapted for use with a fuel stabilizer reservoir, the device configured to contain fuel stabilizer and being actuatable between loading state in which the fuel stabilizer metering device is adapted to receive fuel stabilizer from the fuel stabilizer reservoir and an unloading state in which the fuel stabilizer is dischargeable to a carburetor bowl of an engine, wherein the device is configured to actuate to the unloading state during or after completion of engine shutdown.

2. The apparatus of claim 1, wherein the fuel stabilizer metering device includes a volume movable between a loading position in which the volume is adapted to receive fuel stabilizer from the fuel stabilizer reservoir and an unloading position in which the volume is adapted to discharge fuel stabilizer to the carburetor bowl of the engine.

3. The apparatus of claim 1, wherein the fuel stabilizer metering device is movable to the unloading state in response to a change in vacuum in an intake manifold of the engine.

4. The apparatus of claim 2, wherein the fuel stabilizer metering device comprises:
a plunger including the volume and adapted to be pneumatically coupled to the inlet manifold; and
a spring resiliently biasing the plunger and the volume to the unloading position.

5. The apparatus of claim 4, wherein the plunger includes a circumferential groove providing the volume.

6. The apparatus of claim 1 further comprising:
the reservoir configured to contain the fuel stabilizer; and
the engine including the carburetor bowl.

7. The apparatus of claim 1, wherein the fuel stabilizer metering device includes one or more valves actuatable between open and closed states such that the metering device is adapted receive fuel stabilizer from the fuel stabilizer reservoir when in the loading state and such that the metering device is adapted to discharge fuel stabilizer to the carburetor bowl of the engine when in the unloading state.

8. The apparatus of claim 1 further comprising:
an actuator configured to move the fuel stabilizer metering device between the loading state and the unloading state;
a sensor configured to sense an engine parameter associated with shutting down of the engine; and
a controller configured to generate control signals based upon the engine parameter sensed by the sensor, wherein the actuator is configured to actuate the metering device to the unloading state in response to the control signals.

9. The apparatus of claim 1 further comprising:
an actuator configured to actuate the fuel stabilizer metering device between the loading state and the unloading state;
a controller configured to generate control signals in response to human input shutting down the engine, wherein the actuator is configured to actuate the metering device to the unloading state in response to the control signals.

10. The apparatus of claim 1, wherein the fuel stabilizer metering device is configured to load fuel stabilizer during running of the engine.

11. An apparatus comprising:
a fuel stabilizer metering device configured to discharge fuel stabilizer to a carburetor bowl of an engine after engine shutdown.

12. The apparatus of claim 11, wherein the metering device is actuatable between a loading state in which the metering device is adapted to receive fuel stabilizer from a fuel stabilizer reservoir and an unloading state in which the metering device is adapted to discharge the fuel stabilizer to the carburetor bowl of the engine and wherein the fuel stabilizer metering device is actuatable to the unloading state in response to a change in vacuum in an intake manifold of the engine.

13. The apparatus of claim 12, wherein the fuel stabilizer metering device comprises:
a plunger including a volume for containing fuel stabilizer, the plunger extending within a body adapted to be pneumatically coupled to the intake manifold; and
a spring resiliently biasing the plunger and the volume to the unloading state.

14. The apparatus of claim 11 further comprising:
the reservoir configured to contain the fuel stabilizer; and
the engine including the carburetor bowl.

15. The apparatus of claim 11, wherein the metering device is movable between a loading position in which the metering device is adapted to receive fuel stabilizer from a fuel stabilizer reservoir and an unloading position in which the metering device is adapted to discharge the fuel stabilizer to the carburetor bowl of the engine, the apparatus further comprising:
an actuator configured to move the fuel stabilizer metering device between the loading position and the unloading position;
a sensor configured to sense an engine parameter associated with shutting down of the engine; and
a controller configured to generate control signals based upon the engine parameter sensed by the sensor, wherein the actuator is configured to move the volume to the unloading position in response to the control signals.

16. The apparatus of claim 11, wherein the metering device is movable between a loading position in which the metering device is adapted to receive fuel stabilizer from a fuel stabilizer reservoir and an unloading position in which the metering device is adapted to discharge the fuel stabilizer to the carburetor bowl of the engine, the apparatus further comprising:
an actuator configured to move the fuel stabilizer metering device between the loading position and the unloading position;
a controller configured to generate control signals in response to human input shutting down the engine, wherein the actuator is configured to move the volume to the unloading position in response to the control signals.

17. A method comprising:
at least partially filling a metering volume with a fuel stabilizer while the metering volume is not fluidly coupled to a carburetor bowl of an engine;
discharging fuel stabilizer from the volume into the carburetor bowl while the engine is shutting down or after the engine has shut down: (a) in response to a control signal generated as a result of user input or (b) in response to a parameter associated with shutting down of the engine.

18. The method of claim 17 further comprising automatically moving the metering volume to a position in communication with the carburetor bowl and discharging fuel stabilizer from the volume into the carburetor bowl in response to the parameter associate with shutting down of the engine.

19. The method of claim 18, wherein the volume is automatically moved to the unloading position in communication with the carburetor bowl in response to a change in vacuum from an intake manifold of the engine.

20. The method of claim 17 further comprising moving the volume to the loading position during running of the engine.
